(19) United States
(12) Patent Application Publication
(10) Pub. No.: US 2022/0145586 A1
(43) Pub. Date: May 12, 2022

(54) TRACTOR CAB FRESH AIR INTAKE

(71) Applicant: Deere & Company, Moline, IL (US)

(72) Inventors: Jawahar Naidu, Richmond Hill (CA); Austin L. Begg, Waterloo, IA (US); Daniel J. Knight, Murfreesboro, TN (US)

(21) Appl. No.: 16/949,638

(22) Filed: Nov. 9, 2020

(51) Int. Cl. E02F 9/08; E02F 9/16; B60H 1/00

(52) U.S. Cl. CPC E02F 9/0858; E02F 9/163; B60H 2001/00085; B60H 1/00378; B60H 1/00564; B60H 1/00021

(57) ABSTRACT

A tractor cab fresh air intake includes a pair of air intake covers mounted to a plurality of body panels. Each air intake cover has an air intake opening adjacent a lower end. The body panels may be attached to a pair of C-posts of a tractor cab frame. Air outlet openings adjacent the upper end of each air intake cover extend through the body panels into the pair of C-posts.

### FIELD OF THE INVENTION

The present invention relates to a tractor cab and specifically to a fresh air intake for a tractor cab heating, ventilation and air conditioning system.

### BACKGROUND OF THE INVENTION

Utility tractor cabs may have air conditioning units with fresh air intakes at the rear of the cab or roof. For example, U.S. Pat. No. 7,334,834 for “Tractor Cab Roof with Integral Air Ducts” assigned to Deere & Company describes an evaporator/heater core mounted on the rear panel of a tractor cab roof, with air intakes at the outer periphery of the roof. Roof mounted air ducts do not require any space inside the tractor cab, but can result in dust accumulation in the heating, ventilation and air conditioning (“HVAC”) system, and can be difficult to access for service. A fresh air intake for a tractor HVAC system is needed that does not use space in the cab, minimizes dust accumulation, and is easy to service. Additionally, a fresh air intake is needed that is integrated with the tractor cab body panels.

### SUMMARY OF THE INVENTION

A tractor cab fresh air intake for a HVAC system includes an air intake cover mounted to at least one body panel attached to a hollow tractor cab frame member. The air intake cover provides an upwardly directed air flow path from an intake opening up to an outlet opening through at least one of the body panels and into the hollow tractor cab frame member which provides a passage to a filter for the HVAC system.

### BRIEF DESCRIPTION OF THE DRAWINGS

FIG. 1 is a front perspective view of a tractor cab with a fresh air intake according to a first embodiment of the invention.

FIG. 2 is a partially exploded view of a tractor cab fresh air intake according to a first embodiment of the invention.

FIG. 3 is a side view, partially in cross section, of a tractor cab fresh air intake according to a first embodiment of the invention.

### DESCRIPTION OF THE PREFERRED EMBODIMENT

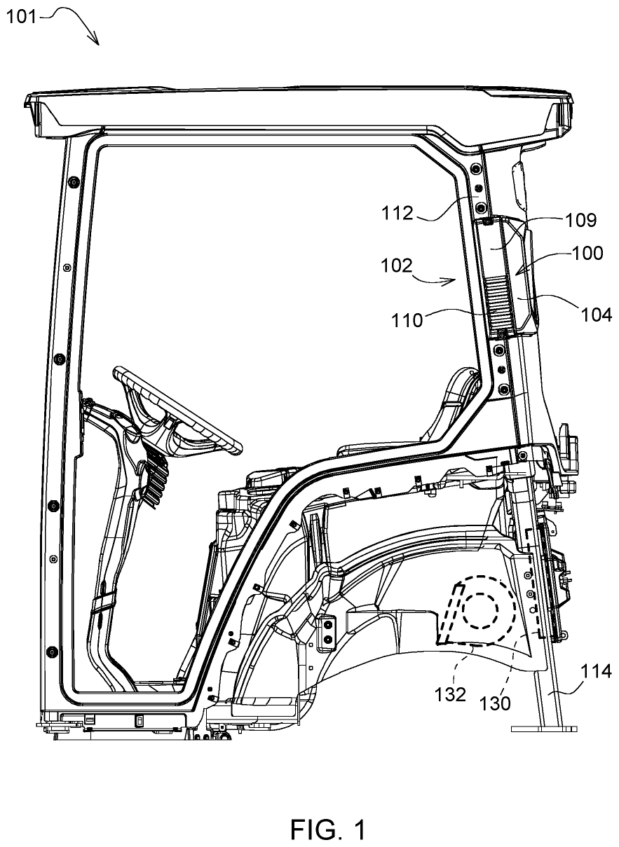

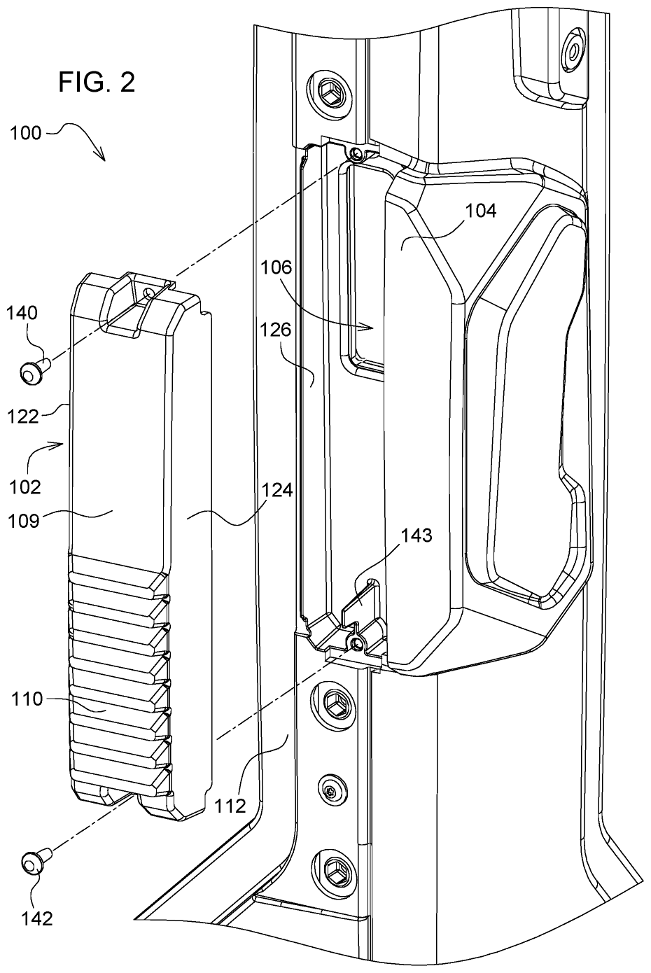

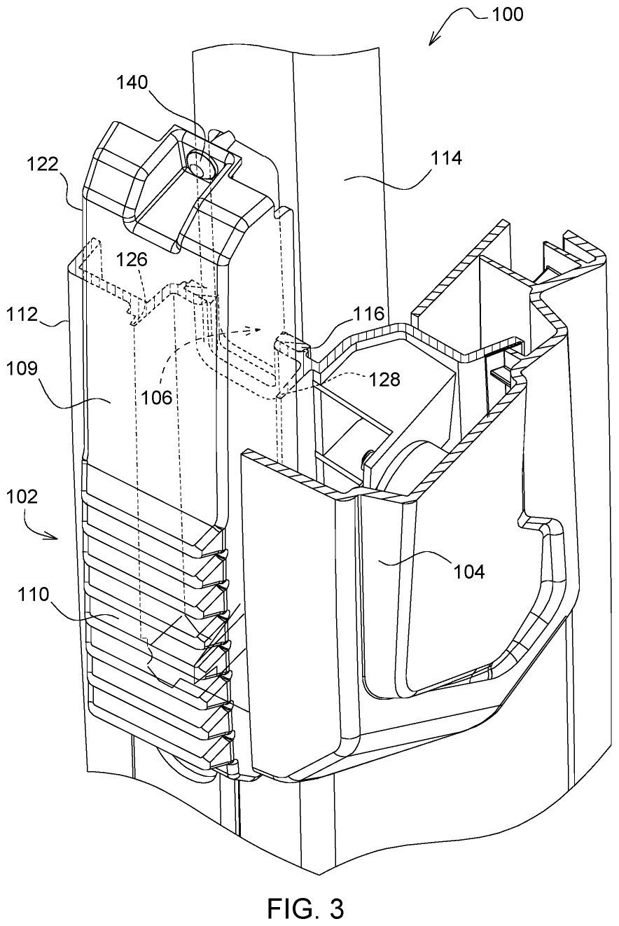

FIGS. 1-3 show one embodiment of tractor cab fresh air intakes 100. A pair of fresh air intakes 100 may be used for a tractor cab's heating, ventilation and air conditioning (“HVAC”) system. The fresh air intakes may get fresh air from outside tractor cab 101 and send the air through passages in the tractor cab frame members to air filters 130. The HVAC system may heat or cool the filtered air with blowers or fans 132 directing the treated air through outlet passages to the interior of the tractor cab.

In one embodiment, each fresh air intake 100 may include air intake cover 102. The air intake cover may be a plastic or sheet metal box mounted to one or more body panels. The body panels may be attached to tractor cab frame members which provide air passages to the HVAC system. For example, the air intake cover may be mounted to a pair of body panels 104, 112, and the body panels may be attached to C-post 114 at the rear corner of the tractor cab frame. The C-posts may be hollow steel members attached to the cab floor and extending up to support a roof covering the cab, and also provide air flow passages into the HVAC system.

In one embodiment, the outer facing surface 109 of air intake cover 102 may be spaced from the body panels to provide a plenum 105 between the air intake cover and one or more body panels. The air intake cover may be mounted to the body panels with threaded fasteners 140, 142 through the top and bottom ends of the air intake cover and into the body panel. Additionally, the left and right side walls 122, 124 of the air intake cover may have an interference fit with the side edges 126, 128 of body panels 104, 112. Optionally, the air intake cover may be in a recessed area of the body panels or between adjacent body panels.

In one embodiment, each air intake cover 102 may have a plurality of air intake openings 110 through the exterior facing surface 109. The air intake openings face outwardly to the left or right side of the tractor cab. All of the air intake openings may be in a lower portion of the air intake cover. Optionally, rib 143 on body panel 104 may fit inside a matching feature at a lower end of the air intake cover to make sure the air intake cover is mounted with the air intake opening at the lower end thereof, and also to help position the threaded fastener into the body panel. The air intake cover provides an air flow path from the air intake openings into plenum 105, and upwardly to air outlet opening 106 at a location higher than air intake openings 110. Louvers may be provided over air intake openings 110 to minimize or prevent entry of water into the air intake. Each air intake cover also provides an upward air flow path which minimizes or prevents ingress of water into the HVAC system, including water from rain or pressure washing, for example.

In one embodiment, fresh air intakes 100 may include air outlet openings 106 through one or more body panels 104, 112 and C-post 114. Seal 116 may be positioned around the air outlet opening between the body panels and C-post. The fresh air may flow through the air outlet opening into the hollow C-post, then downwardly through the hollow passage in the C-post to air filter 130. The fresh air may be heated or cooled and directed with one or more blowers or fans 132 to one or more heating or cooling outlets inside the tractor cab. For example, the blowers or fans may be located inside an air mixing chamber behind each side of the operator seat. The blowers or fans may send treated air into a plurality of air ducts. An air outlet tube may extend upwardly from the air ducts near the front of the cab, and a foot vent through the kick plate may allow air flow from the HVAC unit into the cab.

In one embodiment, fresh air intakes 100 may be easily serviced or cleaned by removing threaded fasteners 140, 142 which hold the air intake covers in place. The fresh air intakes help reduce the amount of dust entering the HVAC system because the fresh air intakes are mounted to body panels on each side of the tractor cab and not behind the tractor cab. Additionally, each fresh air intake cover may include a water drain port between the lower end of the air intake cover and the body panel, allowing water to drain from plenum 105.

Having described the preferred embodiment, it will become apparent that various modifications can be made without departing from the scope of the invention as defined in the accompanying claims.

We claim:

1. A tractor cab fresh air intake, comprising:
an air intake cover mounted to at least one body panel attached to a hollow tractor cab frame member;
the air intake cover providing an upwardly directed air flow path from an air intake opening up to an air outlet opening through at least one of the body panels and into the hollow tractor cab frame member which provides a passage to a filter for a heating, ventilating and air conditioning system.

2. The tractor cab fresh air intake of claim 1 wherein each tractor cab frame member is a C-post at a rear corner of a tractor cab frame.

3. The tractor cab fresh air intake of claim 1 further comprising louvers over the air intake opening.

4. The tractor cab fresh air intake of claim 1 further comprising a water drain port between a lower end of the air intake cover and the at least one body panel.

5. A tractor cab fresh air intake, comprising:
a pair of air intake covers, each air intake cover providing a plenum between an outward facing surface of the air intake cover and a body panel;
an air intake opening with louvers in the outward facing surface of each air intake cover;
an air outlet opening through the body panel and a hollow tractor cab frame member; the air outlet opening positioned above the air intake opening.

6. The tractor cab fresh air intake of claim 5 further comprising a seal around the air outlet opening between the body panel and the hollow tractor cab frame member

7. The tractor cab fresh air intake of claim 5 wherein the hollow tractor cab frame member is a C-post at a rear corner of a tractor cab.

8. The tractor cab fresh air intake of claim 5 further comprising a water drain port from the plenum.

9. A tractor cab fresh air intake, comprising:
a pair of air intake covers mounted to a plurality of body panels; each air intake cover having an air intake opening adjacent a lower end thereof;
the plurality of body panels attached to a pair of C-posts of a tractor cab frame; and
a plurality of outlet openings adjacent an upper end of the pair of air intake covers extend through the plurality of body panels and into the pair of C-posts.

10. The tractor cab fresh air intake of claim 9 further comprising a plurality of louvers over each air intake opening.

11. The tractor cab fresh air intake of claim 9 further comprising a plenum between each of the pair of air intake covers and the plurality of body panels.

12. The tractor cab fresh air intake of claim 9 further comprising a feature on body panel that only fits into the lower end of each of the pair of air intake covers.
